(19) United States
(12) Patent Application Publication
(10) Pub. No.: US 2022/0163212 A1
(43) Pub. Date: May 26, 2022

(54) DUAL ZONE MULTI-PURPOSE COOKING APPARATUS

(71) Applicant: TRISTAR PRODUCTS, INC., Fairfield, NJ (US)

(72) Inventors: James MITRIK, Fairfield, NJ (US); Paul MCGRATH, Fairfield, NJ (US); Alejandro G. LOZANO, Fairfield, NJ (US)

(73) Assignee: TRISTAR PRODUCTS, INC., Fairfield, NJ (US)

(21) Appl. No.: 17/102,942

(22) Filed: Nov. 24, 2020

(51) Int. Cl. F24C 7/08; A47J 37/06; A47J 36/32; A23L 5/10; F24C 15/00; F24C 7/06

(52) U.S. Cl. CPC F24C 7/085; A47J 37/0641; A47J 36/32; A23L 5/15; F24C 15/322; A47J 37/0676; F24C 15/007; F24C 7/067; A23V 2002/00; A23L 5/17

(57) ABSTRACT

The present technology provides a dual zone multi-purpose cooking apparatus with a removable divider between the zones and separate horizontally opening doors for each zone. The multi-purpose cooking apparatus has a cooking chamber that is dividable into two separate cooking chambers that each are able to cook in multiple configurations, such as air frying, grilling, baking, toasting, broiling, or other suitable cooking configuration. The multi-purpose cooking apparatus controls the cooking configuration in each chamber separately to allow different cooking configurations to operate simultaneously. The two chambers are divided by a removable dividing wall. The dividing wall, when inserted between the chambers, separates the heat and the air flow that are provided by separate heating elements and fans in each of the chambers. When the dividing wall is removed, the two chambers combine to form a single, larger chamber.

### FIELD OF INVENTION

The present invention relates to cooking devices. In even greater particularity, the present invention relates to a dual zone multi-purpose cooking apparatus with a removable divider between the zones and separate horizontally opening doors for each zone.

### BACKGROUND

Conventional air fryers and multi-purpose cookers typically have discrete cooking zones that cook in a single configuration. For example, air fryers typically have a single fan and a single heating element in a single cooking chamber. Air fryers cook food items by using a fan to circulate air that is heated by a resistive heating element. Electric grilling devices typically cook food items by using direct heat from a resistive heating element. Baking devices typically cook food items by heating the environment in a chamber to a particular temperature. Broiling devices typically cook food items by heating the item with an upper heating element that is operating at an elevated temperature. Some air fryers may utilize two discrete air fryer chambers in a single unit that operate independently. These conventional cookers do not provide options to users for using a single device to cook multiple different products in multiple different ways simultaneously in a single device.

### SUMMARY OF THE INVENTION

The present technology provides a dual zone multi-purpose cooking apparatus with a removable divider between the zones and separate horizontally opening doors for each zone. The multi-purpose cooking apparatus has a cooking chamber that is dividable into two separate cooking chambers that each are able to cook in multiple configurations, such as air frying, grilling, baking, toasting, broiling, or other suitable cooking configuration. The multi-purpose cooking apparatus controls the cooking configuration in each chamber separately to allow different cooking configurations to operate simultaneously. For example, one chamber may be used to air fry a food product while the other chamber is simultaneously grilling a separate food product.

Each chamber includes different cooking devices to allow the different cooking configurations to be used. For example, each chamber may include an upper heating element with a fan to allow for air frying. The upper heating element may be used for broiling, toasting, grilling, or any other suitable cooking process. Each chamber may include a lower heating element that may be used for grilling, baking, or any other suitable cooking process. The elements, fans, baskets, trays, rotisserie attachments, or any other devices, elements, or accessories may be used to allow each chamber to separately and simultaneously cook different foods in different configurations.

The two chambers are divided by a removable dividing wall. The dividing wall, when inserted between the chambers, separates the heat and the air flow that are provided by separate heating elements and fans in each of the chambers. When the dividing wall is removed, the two chambers combine to form a single, larger chamber. For example, the single chamber may encompass the entire interior of the multi-purpose cooking apparatus. The multi-purpose cooking apparatus may control the power between each of the heating and circulation elements to allow the full chamber to be used for any suitable cooking configuration, such as to bake, air fry, grill, toast, or broil food products.

The multi-purpose cooking apparatus has an interface panel, such as a selection of buttons, knobs, or touchscreens to control the cooking process in any or all of the chambers. The multi-purpose cooking apparatus may have a selector switch that allows a single set of controls to control the cooking environment in both chambers. For example, the selector switch may be switched to left cooking chamber, and the controls are adjustable to control the temperature, cooking configuration, and cooking time in the left chamber. The selector switch may similarly be switched to the right cooking chamber. The selector switch may be switched to control both of the chambers simultaneously. That is, if the divider is removed such that the entire interior of the multi-purpose cooking apparatus is a single chamber, the set of controls may control the entire chamber.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

The drawings are appended hereto and form a portion of this disclosure.

FIG. 1 is a front perspective view of one embodiment of a multi-purpose cooker with the doors closed and the dividing wall removed, in accordance with certain examples of the technology disclosed herein.

FIG. 2 is a front perspective view of one embodiment of a multi-purpose cooker with the doors open and the dividing wall removed, in accordance with certain examples of the technology disclosed herein.

FIG. 3 is a front perspective view of one embodiment of a multi-purpose cooker with the doors closed and the dividing wall installed, in accordance with certain examples of the technology disclosed herein.

FIG. 4 is a front perspective view of one embodiment of a multi-purpose cooker with one door open and the dividing wall installed, in accordance with certain examples of the technology disclosed herein.

FIG. 5 is a front perspective view of one embodiment of a multi-purpose cooker with the doors open and the dividing wall installed, in accordance with certain examples of the technology disclosed herein.

FIG. 6 is a front perspective view of one embodiment of a multi-purpose cooker with the doors open and the dividing wall installed, in accordance with certain examples of the technology disclosed herein.

FIG. 7 is a perspective view of one embodiment of the dividing wall, in accordance with certain examples of the technology disclosed herein.

FIG. 8 is a front perspective view of one embodiment of a multi-purpose cooker with the grid removed and the dividing wall installed, in accordance with certain examples of the technology disclosed herein.

FIG. 9 is a front perspective view of one embodiment of a multi-purpose cooker with the grid removed and the dividing wall removed, in accordance with certain examples of the technology disclosed herein.

FIG. 10 is a bottom perspective view of one embodiment of a multi-purpose cooker, in accordance with certain examples of the technology disclosed herein.

### DETAILED DESCRIPTION

The example embodiments described herein provide a dual zone multi-purpose cooking apparatus with a removable divider between the zones and separate horizontally opening doors for each zone.

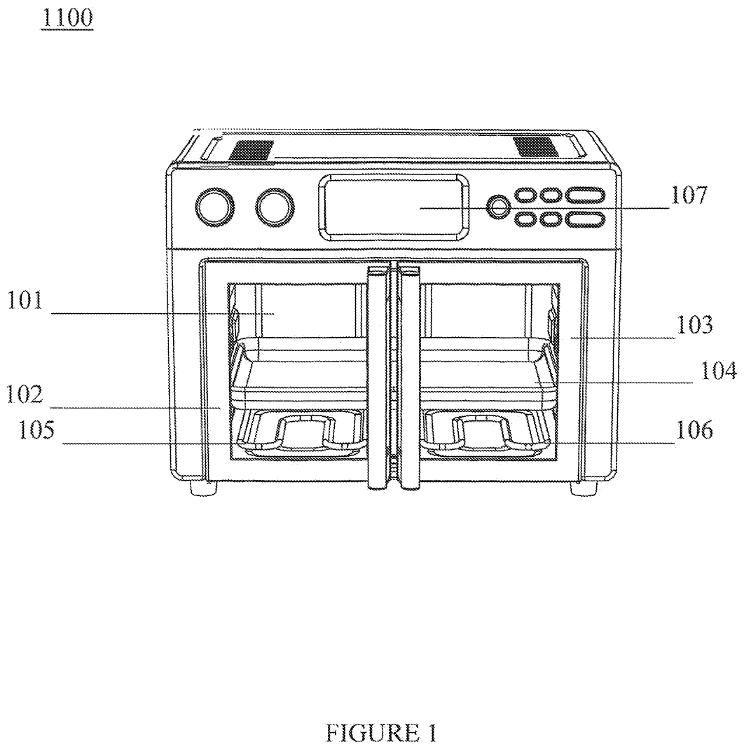

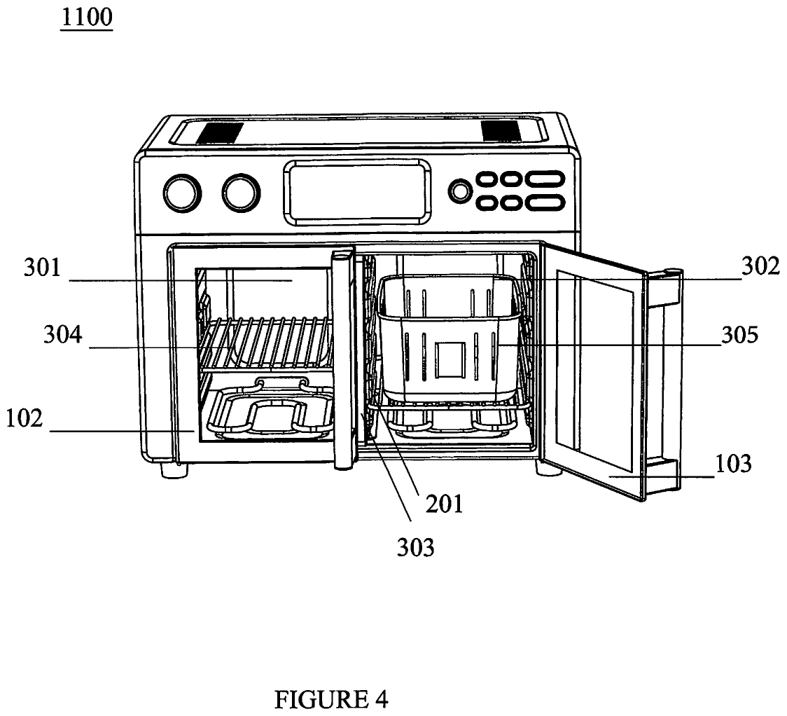

FIG. 1 is a front perspective view of one embodiment of a multi-purpose cooker 1100 with the doors 102, 103 closed and the dividing wall removed, in accordance with certain examples of the technology disclosed herein. The multi-purpose cooker 1100 is configurable to broil, bake, grill, toast, air fry, or in any other suitable manner cook food goods. The multi-purpose cooker 1100 is depicted with two closed doors, a right door 103 and a left door 102. The double access doors 102, 103 may be used to place food and cooking components inside a cooking chamber of the multi-purpose cooker 1100 and/or to remove the food and components. The double access doors 102, 103 are illustrated as being vertically mounted, horizontally and outwardly opening, double access doors to allow either one or both of the double access doors 102, 103 to be opened independently of the other. The door configuration is typically referred to as “French Doors.” The double access doors 102, 103 are illustrated with glass fronts to allow a user to see into the cooking chamber 101 while the doors are closed. When the divider 303 (as depicted in at least FIG. 4) is installed in the multi-purpose cooker 1100, opening a single door allows access to a single compartment without allowing heat to escape from the other compartment. When both double access doors 102, 103 are open at the same time, the entire combined cooking chamber 101 is accessible to place accessories and/or food items in the combined cooking chamber 101. The double access doors 102, 103 include mechanisms that cause the doors to soft close. That is, the doors 102, 103 have a mechanism that slows the closure of the doors so that the doors do not slam when closed too quickly.

A display or control panel 107 is illustrated with features such as temperature display, timer settings, temperature settings, quick start functions, preset cooking processes, or any other suitable controls. The controls may be buttons, toggles, switches, or other physical interface objects. The controls may be digital representations of interface objects. For example, the control panel 107 may be a touchscreen.

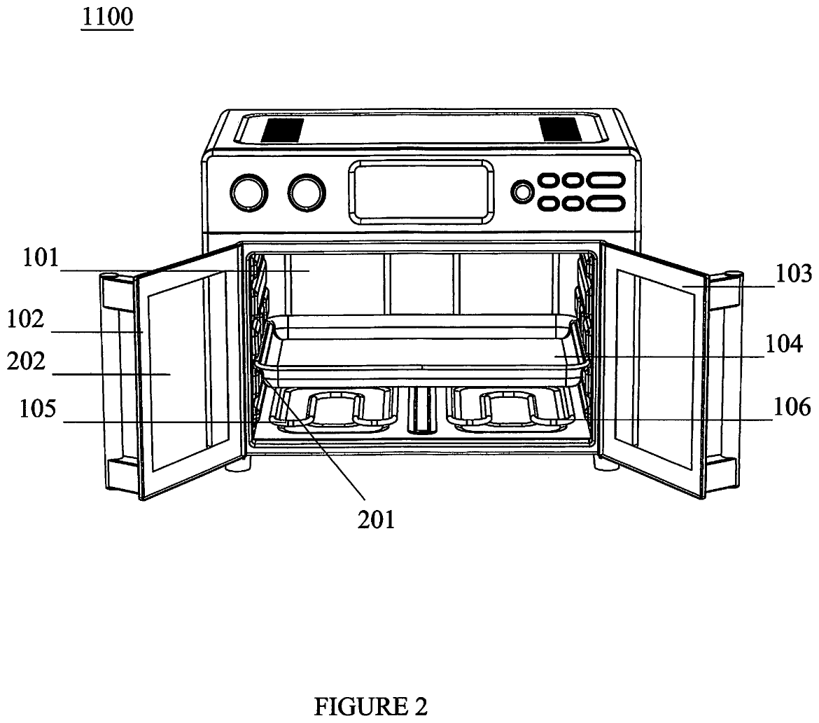

The multi-purpose cooker 1100 is suitable to cook various foods in different configurations, including air frying. The multi-purpose cooker 1100 utilizes one or more of a set of components to cook food products. For example, the multi-purpose cooker 1100 includes components that are configured to grill, air fry, broil, toast, and bake food products. For example, the multi-purpose cooker 1100 may use a grill component, such as a plate with or without raised grilled cross hatching, that is heated to grill meat, vegetables, or other food products. The plate is heated in the chamber via the heated circulated air or simply by a heating element. Another component may be a wire basket or wire bowl for air frying food products. The multi-purpose cooker 1100 in FIG. 1 is illustrated with a pan 104. Edges of the pan 104 are inserted into grooves (such as grooves 201 in FIG. 2) on the walls of the cooking chamber 101 to suspend the pan 104 at a desired height. Alternatively, the pan 104 may be placed on a rack that is mounted on the grooves on the walls of the cooking chamber 101. Any suitable configuration to place food items at the desired height may be used.

The multi-purpose cooker 1100 has heating elements, such as the left lower heating element 105 and the right lower heating element 106. The lower heating elements 105, 106 may be any suitable type of electric resistive heating elements or any other type of element that produces heat from electricity.

FIG. 2 is a front perspective view of one embodiment of a multi-purpose cooker 1100 with the doors 102, 103 open and the dividing wall removed, in accordance with certain examples of the technology disclosed herein. As illustrated the doors 102, 103 open horizontally outward to expose the entirety of the combined cooking chamber 101. The doors 102, 103 are illustrated with glass sections, such as section 202. The glass section 202 allows a user to see into the multi-purpose cooker 1100 without opening the door 102. The doors 102, 103 are hinged at the edges of the multi-purpose cooker 1100 walls to allow the entirety of the cooking chamber 101 to be accessed. Double doors 102, 103 allow the multi-purpose cooker 1100 to be used in a smaller environment. A full, single door requires a greater open space in front of the multi-purpose cooker 1100 to open fully. A smaller, single door would not allow access to the entirety of the cooking chamber 101. The double doors 102, 103 require approximately half of the open space in front of the multi-purpose cooker 1100 to open fully.

Inside the combined cooking chamber 101, the dividing wall is removed such that the pan 104 covers the width of the combined cooking chamber 101. The lower heating elements 105, 106 are both exposed to the combined cooking chamber 101 and together or separately heat the combined cooking chamber 101. Additionally, other heating components, such as the upper heating elements (not shown) may together or separately heat the combined cooking chamber 101.

The edges of the pan 104 are inserted into grooves 201 on the walls of the cooking chamber 101 to suspend the pan 104 at a desired height. Alternatively, the pan 104 may be placed on a rack that is mounted on the grooves 201 on the walls of the cooking chamber 101. Any suitable configuration to place food items at the desired height may be used.

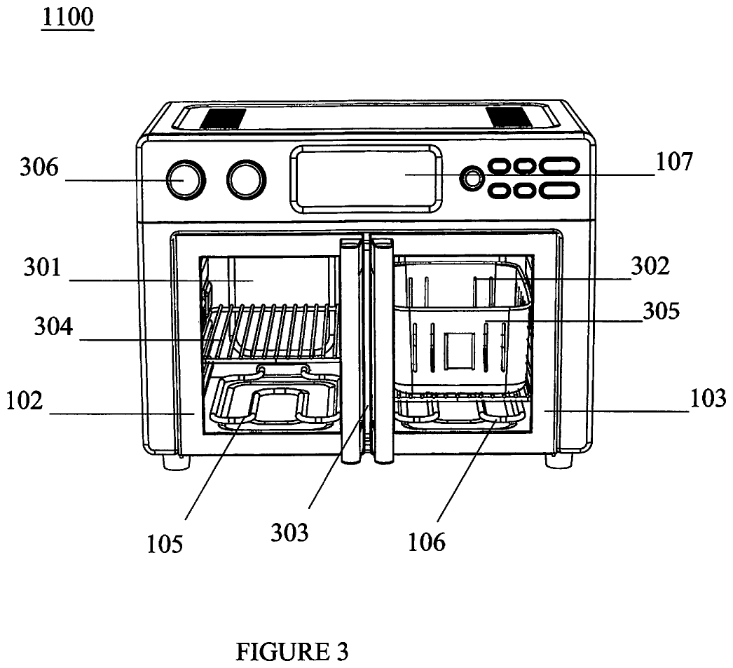

FIG. 3 is a front perspective view of one embodiment of a multi-purpose cooker 1100 with the doors 102, 103 closed and the dividing wall 303 installed, in accordance with certain examples of the technology disclosed herein.

In the example, the dividing wall 303 is installed to separate the combined cooking chamber 101 into a left cooking chamber 301 and a right cooking chamber 302. The dividing wall 303 may be affixed to the body of the multi-purpose cooker 1100 in any suitable manner. For example, the dividing wall 303 may slide into grooves in the body of the multi-purpose cooker 1100. In other examples, the dividing wall 303 may be installed with screws, bolts, clasps, clips, or any other suitable hardware. In certain examples, the dividing wall 303 may be insulated, such as by an insulating material or with an air void.

When the dividing wall 303 is installed, the two cooking chambers 301, 302 are smaller than the combined cooking chamber 101. Therefore, the accessories used are typically smaller. For example, a smaller rack, such as rack 304 is illustrated as being mounted on the grooves on the walls of the left cooking chamber 301 and the dividing wall 303. The rack 304 may be used to support any type of cooking accessory or food item. In another example, an air frying basket 305 is illustrated as being placed on a rack in the right cooking chamber 302. Any suitable accessory may be used to cook food items in the two cooking chambers 301, 302.

A selector switch, such as switch 306, allows a single set of controls to control the cooking environment in both chambers, such as chamber 301 and chamber 302 as described herein. The selector switch 306 may be a knob type switch as illustrated switch 306 or any of the illustrated control switches, buttons, or other interface objects. Any type of interface object may be used to switch the controls. For example, the selector switch 306 may be switched to a left cooking chamber 301 setting, and the control panel 107 is adjustable to control the temperature, cooking configuration, and cooking time in the left chamber 301. The selector switch 306 may similarly be switched to a right cooking chamber 302 setting. The selector switch may be switched to control both of the chambers 301, 302 simultaneously. That is, if the divider 303 is removed such that the entire interior of the multi-purpose cooking apparatus 1100 is a single chamber 101, the control panel 107 may control the entire chamber 101. By using the selector switch 306, the single control panel 107 may be used to control three different cooking chambers 101, 301, 302, thus reducing the number of control buttons, knobs, or switches required to operate the multi-purpose cooking apparatus 1100.

In an example, the controls are programmable to delay start one or both cooking chambers 301, 302. By delaying a start of one side, food products in both sides may finish cooking at the same time, allowing the food to be served fresh and hot.

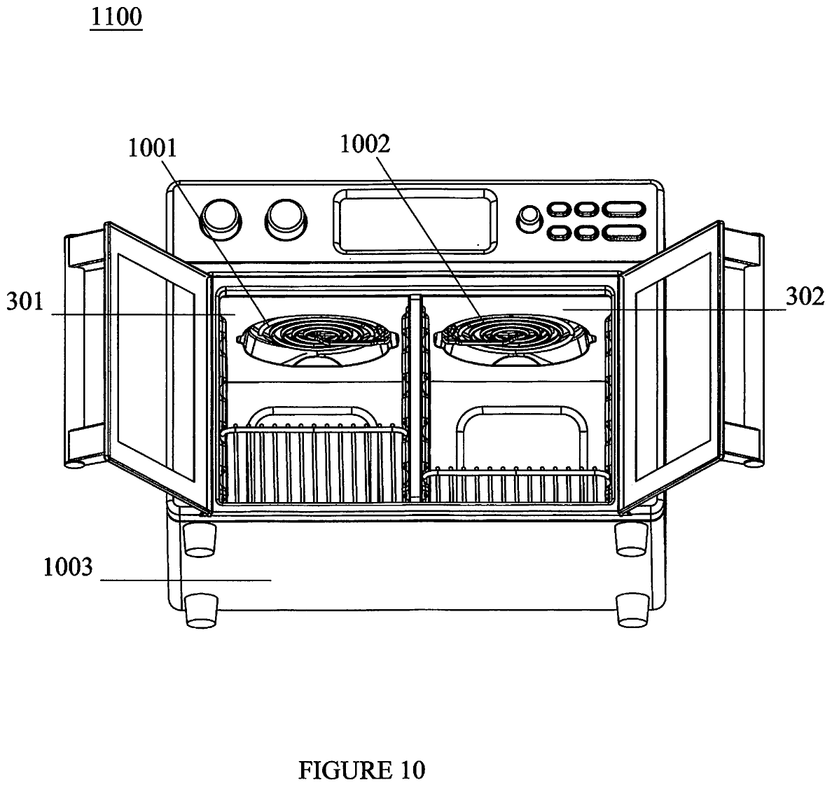

The multi-purpose cooking apparatus 1100 controls the power distribution to the heating elements such as the lower heating elements 105, 106, and the upper heating elements (such as elements 1001 and 1002 in FIG. 10). For example, the multi-purpose cooking apparatus 1100 analyses the settings for each cooking chamber 301, 302, or 101 and determines the power available to operate each heating element. The multi-purpose cooking apparatus 1100 may use an algorithm or other logical determination to distribute the power in a manner that will allow the cooking chamber 301, 302, or 101 to operate efficiently and in a timely manner. The power distribution may depend on the cooking type in each chamber 301, 302, or 101, the accessories used in each chamber 301, 302, or 101, the power available, and any other suitable factors.

FIG. 4 is a front perspective view of one embodiment of a multi-purpose cooker 1100 with one door open 103 and the dividing wall 303 installed, in accordance with certain examples of the technology disclosed herein.

The dividing wall 303 is illustrated dividing the cooking chambers 301, 302 into two substantially equal volumes. The sides of dividing wall 303 are illustrated with grooves 201 to suspend an accessory at a desired height. The dividing wall 303 may insulate the chambers 301, 302 to allow the chambers 301, 302 to be operated at different temperatures. An air frying basket 305 is illustrated as being placed on a rack in the right cooking chamber 302 and a cooking rack 304 is illustrated as being positioned in the left cooking chamber 301.

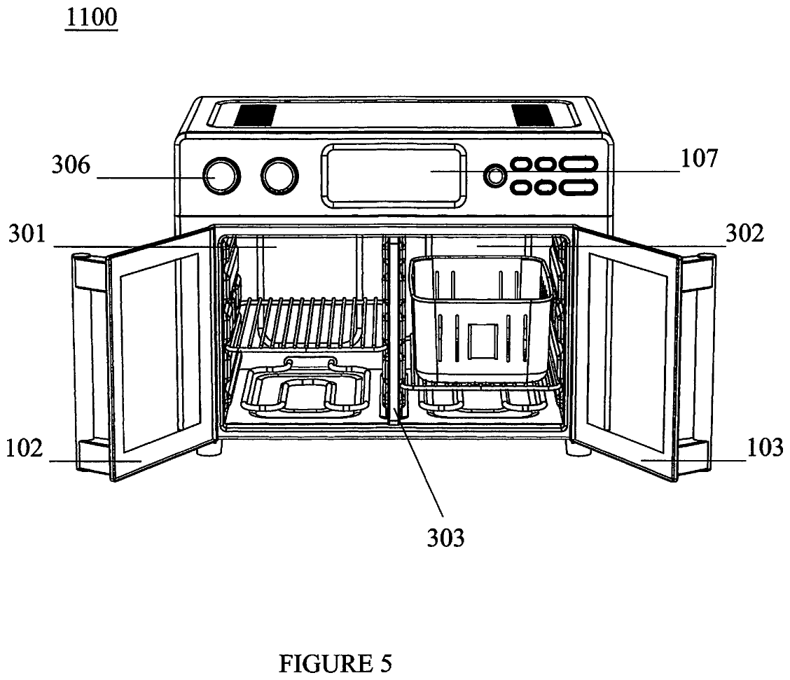

FIG. 5 is a front perspective view of one embodiment of a multi-purpose cooker 1100 with the doors 102, 103 open and the dividing wall 303 installed, in accordance with certain examples of the technology disclosed herein. The left cooking chamber 301 and the right cooking chamber 302 are illustrated as being separate from each other and accessible via the doors 102, 103. In an example, the selector switch 306 may be switched to a setting for the left chamber 301. This selection causes the control panel 107 to control the left chamber 301. Changes or selections made on the control panel 107 when the selector switch 306 is switched to the left chamber 301 would determine the configuration and operation of the left chamber 301, such as the cooking type, the temperature, the cooking duration, a start delay, or any other suitable configuration controls. Similarly, when the selector switch 306 is set to the right chamber 302 or the combined chamber 101, the control panel 107 controls those selected chambers.

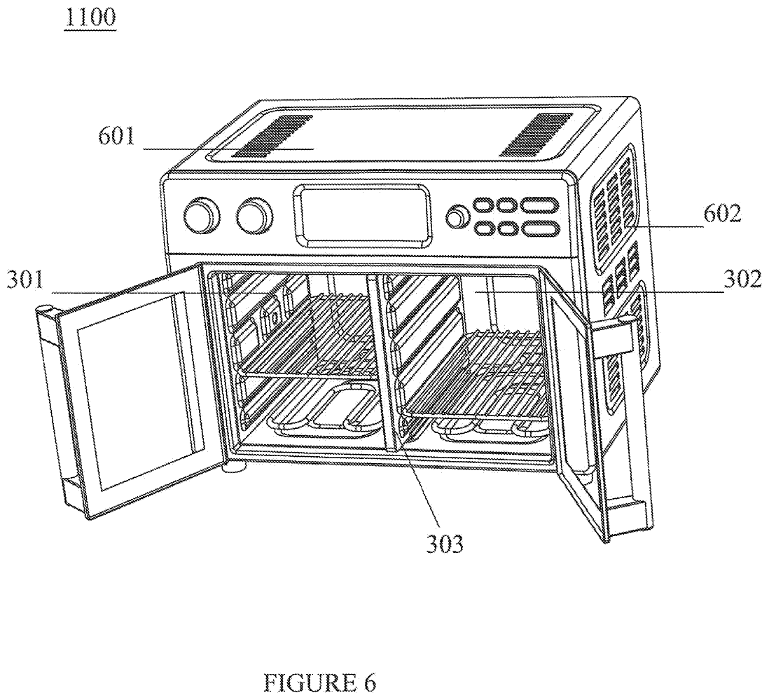

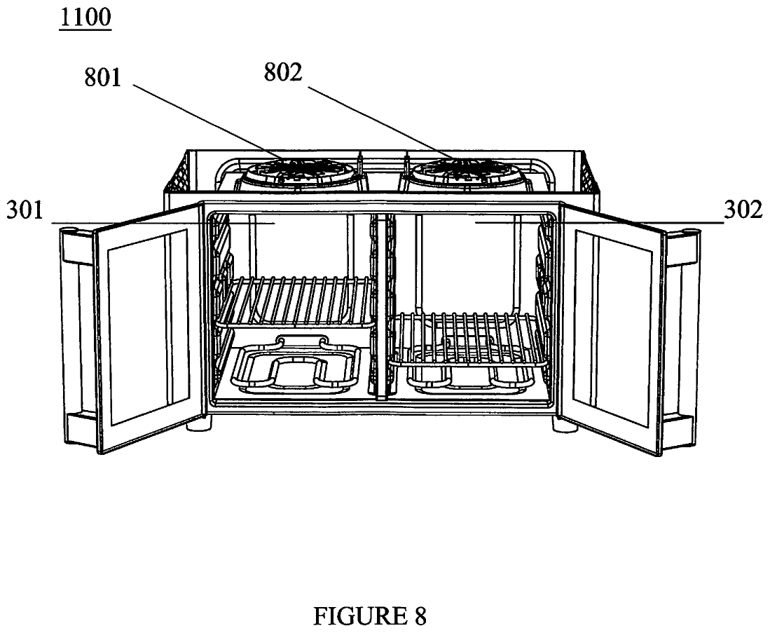

FIG. 6 is a perspective view of one embodiment of a multi-purpose cooker 1100 with the doors 102, 103 open and the dividing wall 303 installed, in accordance with certain examples of the technology disclosed herein. A grid 601 or other type of slotted opening is shown on the top of the multi-purpose cooker 1100. The grid 601 allows air to be drawn into the multi-purpose cooker 1100 and be fed to the fans (such as fans 801 and 802 in FIG. 8). The air is heated and circulated in the chamber 301, 302, or 101 to heat food, such as when the multi-purpose cooker 1100 is cooking as an air fryer. Air is expelled from the multi-purpose cooker 1100 via vents 602. The vents 602 may be located in any suitable location around the exterior of the multi-purpose cooker 1100. In certain examples, the air is filtered or otherwise cleaned before being vented to the outside of the multi-purpose cooker 1100. The filtering removes at least a portion of the particulates and smoke in the circulated air.

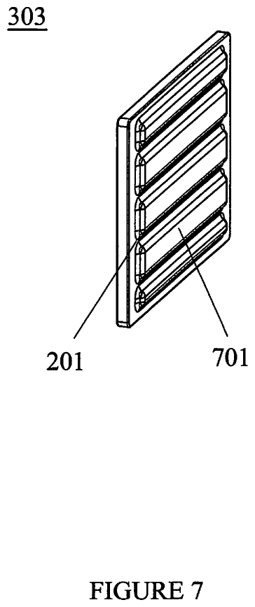

FIG. 7 is a perspective view of one embodiment of the dividing wall 303, in accordance with certain examples of the technology disclosed herein. The dividing wall 303 is illustrated with panels 701. The panels 701 create grooves 201 for supporting racks, trays, or other accessories. In alternate examples, the dividing wall 303 may have insulation or other temperature controlling elements to isolate the temperature in each chamber 301, 302. Similar panels 701 and grooves 201 may be used on any of the walls of the multi-purpose cooker 1100.

The dividing wall 303 may slide into grooves or other mating structure in the body of the multi-purpose cooker 1100. In other examples, the dividing wall 303 may be installed with screws, bolts, clasps, clips, or any other suitable hardware. In certain examples, the dividing wall 303 may be insulated, such as by an insulating material or with an air void. The dividing wall 303 may be constructed of any type of material suitable for use inside of the multi-purpose cooker 1100, such as aluminum, stainless steel, ceramic, or other suitable materials.

FIG. 8 is a front perspective view of one embodiment of a multi-purpose cooker 1100 with the grid 601 removed and the dividing wall 303 installed, in accordance with certain examples of the technology disclosed herein. As illustrated, under the grid 601 (not shown) are two fans 801, 802. The fans are used, for example, when air frying food items. The air fryer function circulates heated air to cook the food. In an example, the chambers 301, 302 operate independently such that the fans 801, 802 are used only when the particular chamber 301, 302 require the fans. For example, if the user elects to operate the left chamber 301 as an air fryer and right chamber 302 as a grill, only the left fan 801 is required. The left fan 801 engages and circulates heated air around the left chamber 301 to air fry the food products. The right fan 802 is left unused while right chamber 302 is used to grill food items.

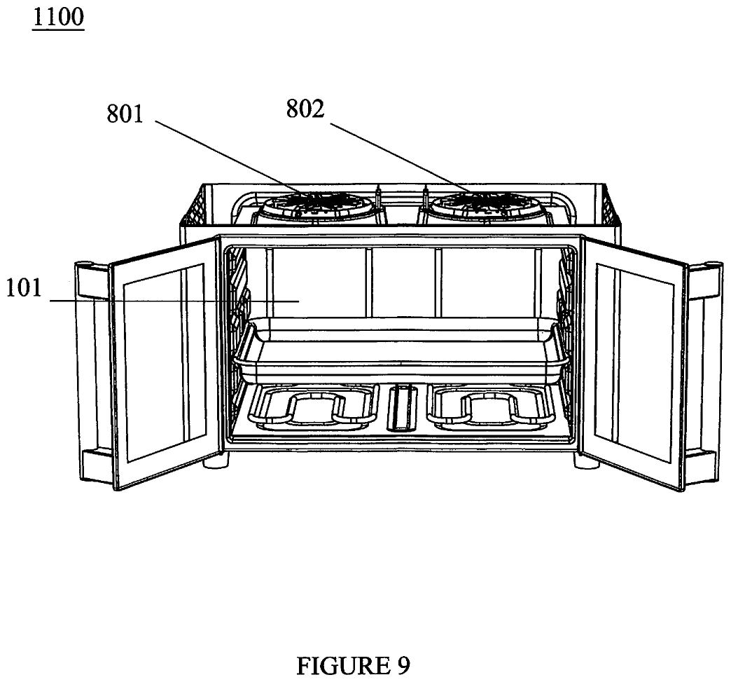

FIG. 9 is a front perspective view of one embodiment of a multi-purpose cooker 1100 with the grid 601 removed and the dividing wall 303 removed, in accordance with certain examples of the technology disclosed herein. In an example, the combined chamber 101 operates independently such that the fans 801, 802 are both used when the combined chamber 101 requires the fans. For example, if the user elects to operate the combined chamber 101 as an air fryer, both the left fan 801 and the right fan 802 may be required. The left fan 801 and the right fan 802 engage and circulate heated air around the combined chamber 101 to air fry the food products.

FIG. 10 is a bottom perspective view of one embodiment of a multi-purpose cooker 1100, in accordance with certain examples of the technology disclosed herein. The bottom 1003 of the multi-purpose cooker 1100 is illustrated under the chambers 301, 302. The left upper heating element 1001 and the right upper heating element 1002 are illustrated under the fans 801, 802 (not shown). The upper heating elements 1001, 1002 may be similar in manufacture and performance to the lower heating elements 105, 106. The upper heating elements 1001, 1002 may be used in conjunction with the fans 801, 802 when air frying food items. In an example, the upper heating elements 1001, 1002 heat the air that is circulated by the fans 801, 802.

In an example, the chambers 301, 302 operate independently such that the upper heating elements 1001, 1002 are used only when the particular chamber 301, 302 requires a heating element. For example, if the user elects to operate the left chamber 301 as an air fryer and right chamber 302 as a grill, only the left upper heating element 1001 is required. The left upper heating element 1001 engages and heats air to be circulated around the left chamber 301 to air fry the food products. The right upper heating element 1002 is left unused while right chamber 302 is used to grill food items. In an example, the combined chamber 101 operates independently such that the upper heating elements 1001, 1002 are both used when the combined chamber 101 requires a heating element. For example, if the user elects to operate the combined chamber 101 as an air fryer, both upper heating elements 1001, 1002 may be required. The left upper heating element 1001 and the right upper heating element 1002 engage and heat air to be circulated around the combined chamber 101 to air fry the food products.

1. A multi-function cooking apparatus, comprising:
a combined chamber comprising a rack, a grilling plate that grills food products when used in the combined chamber, and a wire container that air fries food products when used in the combined chamber, wherein the rack, the grilling plate, and the wire container are used in the combined chamber alternatively;
a removable divider wall that, when installed, divides the combined chamber into two or more smaller chambers, each of the two or more smaller chambers configurable to grill food products or air fry food products, wherein when the divider wall is installed, a first configured one of the two or more smaller chambers comprises the grilling plate that grills the food products by operating a first heater and a first fan in the first one of the two or more smaller chambers, and a second configured one of the two or more smaller chambers simultaneously comprises the wire container that air fries the food products by operating a second heater and a second fan in the second one of the two or more smaller chambers, wherein the first heater and the second heater and the first fan and the second fan operate independently; and
a user interface panel comprising a selector switch positionable between at least a first position, a second position, and a third position, the first position causing the control panel to control the first heater and the first fan in the first configured one of the two or more smaller chambers, the second position causing the control panel to control the second heater and the second fan in the second configured one of the two or more smaller chambers, and the third position causing the control panel to jointly control the first heater and the first fan and the second heater and the second fan in the combined chamber.

2. The apparatus of claim 1, further comprising two vertically mounted, horizontally opening doors to access the chamber, wherein each of the two doors opens independently.

3. The apparatus of claim 1, wherein when the divider wall is installed, one of the two or more smaller chambers created by dividing the combined chamber separately and simultaneously air fries the food products and a second one of the two or more smaller chambers bakes food products by operating a heater in each of the two or more smaller chambers independently.

4. The apparatus of claim 3, wherein the apparatus is configurable to distribute power to heating elements in each of the two or more smaller chambers based on a selected configuration for each of the two or more smaller chambers.

5. The apparatus of claim 1, wherein when the divider wall is removed the combined chamber is configurable to grill, air fry, broil, toast, and bake food products.

6. The apparatus of claim 1, wherein, when the dividing wall is installed, each of the smaller chambers comprises a lower heating element, an upper heating element, and a fan that operate independently from each other.

7. (canceled)

8. The apparatus of claim 1, wherein each of the smaller chambers is configurable to start on a configured delay to allow a cooking cycle for each of the smaller chambers to complete simultaneously.

9. The apparatus of claim 6, wherein, when the dividing wall is removed, the combined chamber of the apparatus is configurable to operate the upper heating element and the fan from each of the smaller chambers to air fry a food item in the combined chamber.

10. A method to operate a multi-function cooking apparatus, comprising:
placing food items into a combined chamber of an apparatus, the combined chamber comprising components that alternatively air fry, grill, broil, toast, and bake food components;
air frying food products in the combined chamber;
installing a removable divider wall that divides the chamber into two or more smaller chambers;
installing, in a first one of the two or more smaller chambers, a grilling plate that grills food products and, in a second one of the two or more smaller chambers, a wire container that air fries food products;
simultaneously operating a first heater in the first one of the two or more two or more smaller chambers to grill the food products in the first one of the two or more two or more smaller chambers and a second heater in the second one of the two or more smaller chambers to air fry the food products in the second one of the two or more smaller chambers, wherein the first heater and the second heater operate independently;
setting a selector switch on a user interface to a first position causing the control panel to control the first heater and the first fan in the first configured one of the two or more smaller chambers;
setting the selector switch on the user interface to a second position causing the control panel to control the second heater and the second fan in the second configured one of the two or more smaller chambers; and
setting the selector switch on the user interface to a third position causing the control panel to jointly control the first heater and the first fan and the second heater and the second fan in the combined chamber.

11. The method of claim 10, further comprising opening two vertically mounted, horizontally opening doors to access an interior of the apparatus; and

12. The method of claim 10, further comprising installing the divider wall such that each of the two or more smaller chambers is separately and simultaneously configurable to grill, air fry, broil, toast, or bake food products.

13. The method of claim 10, wherein the apparatus is configurable to distribute power to heating elements in each of the two or more smaller chambers based on a selected configuration for each of the two or more smaller chambers.

14. The method of claim 10, further comprising removing the divider wall such that the combined chamber is configurable to grill, air fry, broil, toast, and bake food products.

15. The method of claim 10, wherein, when the dividing wall is installed, each of the smaller chambers comprises a lower heating element, an upper heating element, and a fan that operate independently from each other.

16. (canceled)

17. The method of claim 10, further comprising configuring a set of cooking controls to cause one or more of the combined chamber or one of the smaller chambers to start a cooking cycle after a delay.

18. The method of claim 15, wherein, when the dividing wall is removed, the combined chamber of the apparatus is configurable to operate the upper heating element and the fan from each of the smaller chambers to air fry a food item in the combined chamber.

19. The apparatus of claim 1, wherein the first fan is not engaged when the first one of the two or more smaller chambers comprises the grilling plate that grills the food products and the second fan is engaged when the first one of the two or more smaller chambers comprises the wire container air fries the food products.

20. The apparatus of claim 1, wherein an upper heater in the first one of the two or more smaller chambers does not engage when the first one of the two or more smaller chambers comprises the grilling plate that grills the food products and an upper heater in the second one of the two or more smaller chambers engages when the second one of the two or more smaller chambers comprises the wire container air fries the food products.
